(19) United States
(12) Patent Application Publication
(10) Pub. No.: US 2026/0024395 A1
(43) Pub. Date: Jan. 22, 2026

(54) MONEY DEPOSITING APPARATUS, MONEY HANDLING SYSTEM, AND MONEY HANDLING METHOD

(71) Applicant: Glory Ltd., Himeji-shi (JP)

(72) Inventors: Risa HORITA, Himeji-shi (JP); Makoto ASO, Himeji-shi (JP)

(73) Assignee: Glory Ltd., Himeji-shi (JP)

(21) Appl. No.: 19/339,367

(22) Filed: Sep. 25, 2025

Related U.S. Application Data
(63) Continuation of application No. PCT/JP2024/010011, filed on Mar. 14, 2024.

(30) Foreign Application Priority Data
Mar. 27, 2023 (JP) 2023-050028

(51) Int. Cl. G07D 11/235; G07D 1/06; G07D 3/16; G07D 5/00; G07D 9/00; G07D 11/23; G07D 11/26

(52) U.S. Cl. CPC G07D 11/235; G07D 1/06; G07D 3/16; G07D 9/002; G07D 11/23; G07D 11/26; G07D 5/00

(57) ABSTRACT

In order to provide a money handling system to divert money among plural apparatuses, the money handling system is provided with: a money handling apparatus that performs a dispensing process of discharging money stored in a storage unit to outside the apparatus; a depositing apparatus that receives deposited money, stores money of predetermined denominations for which a quantity of money of each denomination is set in advance for replenishing the money handling apparatus in a replenishment container, and stores money other than the predetermined money for replenishing the money handling apparatus in a normal container; and a management apparatus that notifies information on replenishment work for replenishing the money handling apparatus with money in the replenishment container.

### CROSS-REFERENCE RELATED TO APPLICATIONS

The present application is a bypass continuation of, and claims priority to, International application PCT/JP2024/010011, filed Mar. 14, 2024, the entire contents of which are incorporate d herein by reference. PCT/JP2024/010011 claims priority to JP2023-050028, filed Mar. 27, 2023, the entire contents of which are in corporated herein by reference.

### TECHNICAL FIELD

The present disclosure relates to a money depositing apparatus for receiving money, a money handling system including the money depositing apparatus, and a money handling method performed in the money handling system.

### BACKGROUND ART

Conventionally, a system in which a money depositing apparatus installed at a store receives money to be deposited therein and issues a predetermined valuable medium such as a coupon redeemable at the store, has been used. A system is known in which a coupon is issued in exchange for coins received from a customer. For example, when a customer who saved coins at home deposits these coins into a coin exchange device installed at a store, a coupon corresponding to the deposited amount is issued from the device. The customer can use the obtained coupon for payment to purchase an item at the store. In such a system, a large quantity of coins saved in a bottle or the like are often deposited into the device. If a storage area for coins arranged inside the coin exchange device has reached its capacity, the customer cannot use the device to deposit coins. Thus, when the quantity of coins in the storage area is approaching full capacity, the coin exchange device lights up an indicator to notify a clerk that the storage area needs to be emptied.

### SUMMARY

A money handling system according to one aspect of the present disclosure includes: a money handling apparatus that performs a dispensing process to discharge money stored in a storage unit to outside the apparatus; a depositing apparatus that receives deposited money, stores money of predetermined denominations for which a quantity of money of each denomination is set in advance for replenishing the money handling apparatus in a replenishment container, and stores money other than the predetermine money for replenishing the money handling apparatus in a normal container; and a management apparatus that notifies information on replenishment work for replenishing the money handling apparatus with money in the replenishment container. The depositing apparatus may receive money deposited by a customer of a store, and the management apparatus may notify a clerk of the information on the replenishment work. The management apparatus may notify information on the replenishment container and information on a money handling apparatus to be replenished with money in the replenishment container. The notification may be performed by displaying the related information on a display of the management apparatus, a display of the depositing apparatus, a display of the money handling apparatus, or the like. The notification may be performed by transmitting a message from the management apparatus to an external device such as a mobile terminal.

### BRIEF DESCRIPTION OF THE DRAWINGS

FIG. 1 illustrates an outline of a money handling system according to the present embodiment.

FIG. 2 is a schematic diagram showing an example of a configuration of the money handling system.

FIGS. 3A, 3B and 3C each show a schematic diagram illustrating an example of a configuration of a money handling apparatus used as a back apparatus.

FIG. 4 is a block diagram showing an example of the configuration of the money handling system.

FIGS. 5A and 5B illustrate inventory information managed in the money handling system.

FIG. 6 is a flowchart showing a flow of a process performed by a management apparatus.

FIG. 7 illustrates a method to be determined by the management apparatus for handling surplus coins.

FIGS. 8A and 8B illustrate an example of handling of surplus coins generated during replenishment.

### DESCRIPTION OF EMBODIMENTS

Hereinafter, an embodiment of a money depositing apparatus, a money handling system including the money depositing apparatus, and a money handling method performed in the money handling system, according to the present disclosure, will be described with reference to the accompanying drawings.

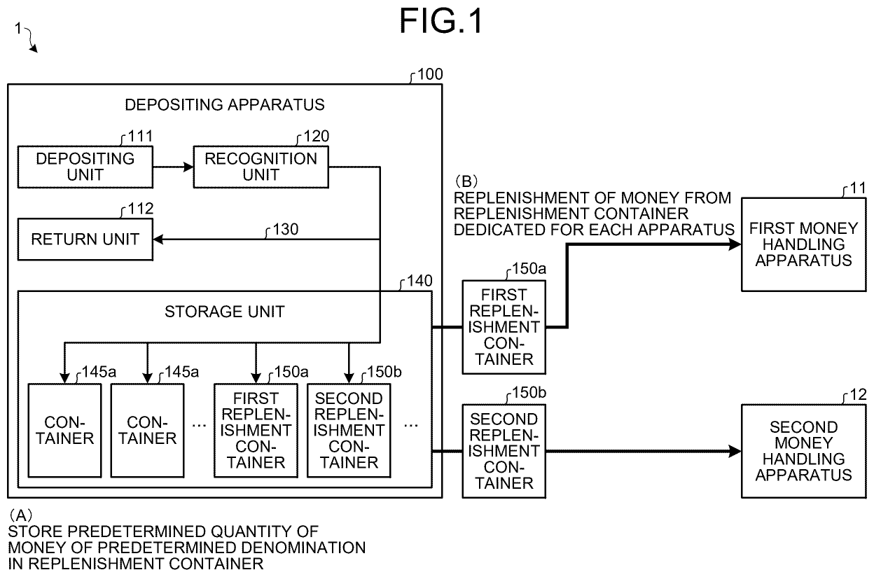

FIG. 1 illustrates an outline of a money handling system 1 according to the present embodiment. The money handling system 1 includes a depositing apparatus (money depositing apparatus) 100 and a plurality of money handling apparatuses 11, 12. These apparatuses 11, 12, 100 are installed in a store. The depositing apparatus 100 performs a depositing process for receiving money and storing the money inside the apparatus. The money handling performed by each of the money handling apparatuses 11, 12 includes at least a dispensing process for discharging money stored therein to outside the apparatus. If money in the money handling apparatus 11, 12 runs short, the dispensing process cannot be performed by that apparatus. Therefore, a clerk of the store performs, according to need, replenishment work for collecting money from the depositing apparatus 100 and replenishing the money handling apparatus 11, 12 with the collected money.

The depositing apparatus 100 receives a plurality of pieces of money to be deposited therein at a depositing unit 111. The depositing unit 111 feeds out the pieces of money one by one to a transport path inside the apparatus, and a transport unit 130 transports each piece of money. A recognition unit 120 recognizes denominations of the money transported by the transport unit 130. Based on the recognition result, the transport unit 130 transports each piece of money to a return unit 112 or a storage unit 140. Money that cannot be stored in the storage unit 140, money that cannot be recognized by the recognition unit 120, and the like are returned from the return unit 112. Money that can be stored in the depositing apparatus 100 is transported to the storage unit 140 by the transport unit 130 and stored in the storage unit 140.

The storage unit 140 includes a plurality of containers for storing money. Each container can be set as a normal container 145 or a replenishment container 150 to store money for replenishing another money handling apparatus, based on an operation by the clerk. All the plurality of containers may be set as normal containers 145. All the plurality of containers may be set as replenishment containers 150. As shown in FIG. 1, the storage unit 140 stores money in the normal containers 145 (145a, 145b), and the replenishment containers 150 (150a, 150b) that store money for replenishing the other money handling apparatuses 11, 12. The normal containers 145 and the replenishment containers 150 are detachably mounted to the storage unit 140, i.e., to the depositing apparatus 100. The normal containers 145 and the replenishment containers 150 do not feed out money. For example, a container in the form of a bag for storing money inside a bag body can be used as the normal container 145 and as the replenishment container 150. A container of the same type may be used as the normal container 145 and as the replenishment container 150. The number of the normal containers 145 in the depositing apparatus 100 is not particularly limited. The number of the replenishment containers 150 in the depositing apparatus 100 is not particularly limited.

For example, the normal container 145 stores money of all denominations. The denomination of money to be stored in the normal container 145 may be set in advance. When the denomination has been set, money of the set denomination is stored in the normal container 145. In the normal container 145, money is stored up to a predetermined capacity until the depositing apparatus 100 determines that the normal container 145 is full.

A denomination of money to be stored in each replenishment container 150 and a quantity of that money to be stored therein can be set in advance. For example, one denomination and a quantity for this denomination are set for one replenishment container 150. For another example, a plurality of denominations and the quantity for each denomination are set for one replenishment container 150. When a plurality of denominations have been set for one container 150, the plurality of denominations of money are stored in a mixed state in this replenishment container 150.

If the money recognized by the recognition unit 120 can be stored in both the normal container 145 and the replenishment container 150, the depositing apparatus 100 stores the money in the replenishment container 150. That is, the depositing apparatus 100 stores money preferentially in the replenishment container 150 rather than the normal container 145. When a quantity of money, whose denomination is assigned to both the normal container 145 and the replenishment container 150, stored in the replenishment container 150 reaches a predetermined quantity set in advance, the depositing apparatus 100 thereafter stores money of the same denomination in the normal container 145.

Priorities may be set for the replenishment containers 150. If the money recognized by the recognition unit 120 can be stored in a plurality of replenishment containers 150, the depositing apparatus 100 determines the replenishment container 150 with the highest priority as a storage destination of the money. The depositing apparatus 100 stores the money in the replenishment container 150 determined as the storage destination. When the quantity of money stored in the replenishment container 150 with the highest priority reaches a predetermined quantity set in advance, the depositing apparatus 100 determines another replenishment container 150 with the next highest priority, as a storage destination for money of the same denomination. Thereafter, the depositing apparatus 100 stores the money in the newly determined replenishment container 150.

In this way, money is stored in the replenishment containers 150, in order from the replenishment container 150 with the highest priority, until the quantity of stored money reaches a predetermined quantity set for that container, and thereafter money is stored in the normal container 145. If priorities are not set for the replenishment containers 150, money is stored in the replenishment containers 150 sequentially. For example, supposing that a setting is made to store 100 pieces of money of a certain denomination in a first replenishment container 150a and to store 200 pieces of money of the same denomination in a second replenishment container 150b. In this case, if the first replenishment container 150a is prioritized over the second replenishment container 150b, 100 pieces of money are stored in the first replenishment container 150a and thereafter 200 pieces of money are stored in the second replenishment container 150b. On the other hand, if no priorities are set for these containers 150a, 150b, money may be stored alternately such that one piece of money is stored in the first replenishment container 150a, and then in the second replenishment container 150b.

The depositing apparatus 100 stores money in the replenishment containers 150 preferentially to the normal containers 145 until money of the preset denominations is stored in the replenishment containers 150 in the preset quantity for each denomination. While storing money in the replenishment containers 150, the depositing apparatus 100 stores money that is not to be stored in the replenishment containers 150, in the normal containers 145. In other words, of the money deposited through the depositing unit 111, the depositing apparatus 100 stores, in the replenishment container 150, all the money that can be stored in the replenishment container 150, and stores the remaining money in the normal container 145.

For example, if the clerk sets the first replenishment container 150a as a dedicated container for the first money handling apparatus 11 and sets a plurality of denominations and the quantity for each denomination to be supplied to the first money handling apparatus 11, money of the set denominations is stored in the first replenishment container 150a in a mixed state in the set quantity for each denomination. If the clerk sets the second replenishment container 150b as a dedicated container for the second money handling apparatus 12 and sets one denomination and the quantity to be supplied to the second money handling apparatus 12, the set quantity of money of the set denomination is stored in the second replenish container 150b. If the first replenishment container 150a is prioritized over the second replenishment container 150b, money is preferentially stored in the first replenishment container 150a rather than the second replenishment container 150b.

As shown in FIG. 1, a predetermined quantity of money of a predetermined denomination is stored in each replenishment container 150 (A). The clerk dismounts the first replenishment container 150a from the depositing apparatus 100, and replenishes the first money handling apparatus 11 with money stored in the first replenishment container 150a (B). The clerk dismounts the second replenishment container 150b from the depositing apparatus 100, and replenishes the second money handling apparatus 12 with money stored in the second replenishment container 150b (B).

In the money handling system 1, when replenishment work for replenishing the money handling apparatus 11, 12 with the money in the replenishment container 150 is required, a notification process to the clerk is performed. When the money stored in the money handling apparatus 11, 12 decreases and the money handling apparatus 11, 12 needs to be replenished with money, the money handling apparatus 11, 12 performs a notification process for notifying the clerk of this fact. When money of all denominations set by the clerk is stored in the replenishment container 15 in the quantity set for each denomination by the clerk, the depositing apparatus 100 performs a notification process for notifying the clerk of this fact. In the notification processes, the clerk is notified of information relating to the replenishment work. For example, the clerk is notified which one of the plurality of replenishment containers 150 in the depositing apparatus 100 is to be dismounted, and which one of the money handling apparatuses 11, 12 is to be replenished with money. The notification process may be performed by a management apparatus that manages the depositing apparatus 100 and the money handling apparatuses 11, 12, which will be described later.

As described above, in the money handling system 1, the depositing apparatus 100 can be used as an apparatus that prepares money for replenishing the money handling apparatus 11, 12 and stores the prepared money in the containers. For example, there is a store where denominations and the quantity for each denomination of money to be used for replenishing each money handling apparatus have been determined in advance. In this store, the denominations and the quantity for each denomination of money for replenishing each money handling apparatus are set to each replenishment container 150 dedicated and assigned to respective apparatus. The clerk can easily perform the replenishment work by simply dismounting the replenishment container 150 from the depositing apparatus 100, carrying the replenishment container 150 to the corresponding money handling apparatus 11, 12, and replenishing the apparatus 11, 12 with the money in the replenishment container 150.

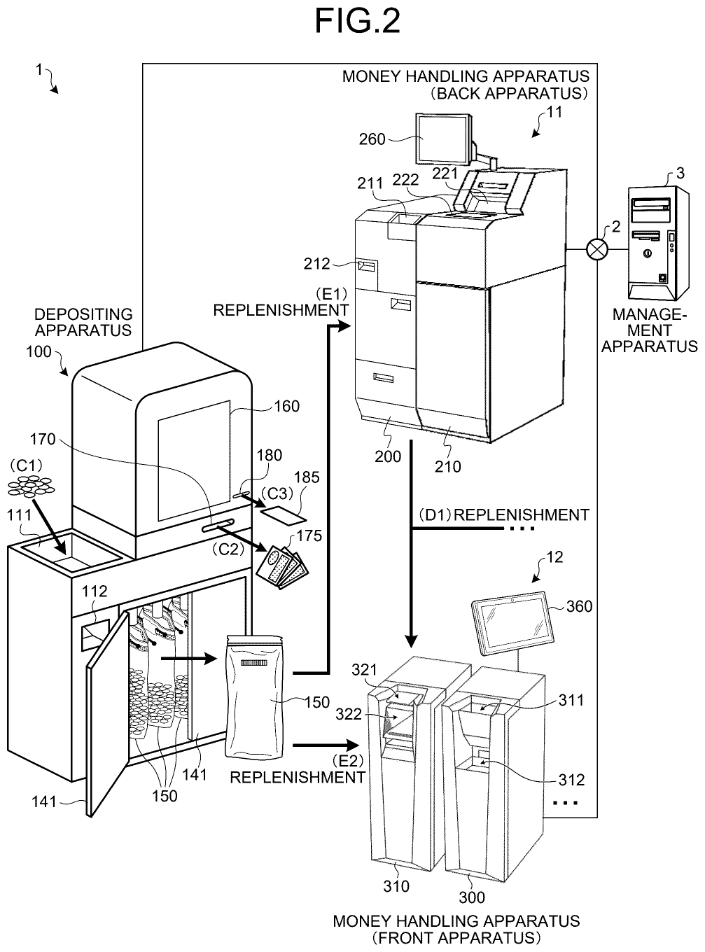

Next, a specific example of the money handling system 1 will be described. FIG. 2 is a schematic diagram showing an example of the configuration of the money handling system 1. The money handling system 1 shown in FIG. 2 includes the depositing apparatus 100, the money handling apparatus 11 used in a back office of the store, the money handling apparatus 12 used at a checkout counter of the store, and a management apparatus 3 that stores and manages various information relating to these apparatuses 11, 12, 100 used in a store. The depositing apparatus 100, the money handling apparatuses 11, 12, and the management apparatus 3 are communicably connected to each other via a network 2. The numbers of the depositing apparatuses 100 and the money handling apparatuses 11, 12 installed in the store are not particularly limited. The description will be continued with an example in which one depositing apparatus 100, one money handling apparatus 11, and a plurality of money handling apparatuses 12 are installed in the store.

The money handling apparatus 11 includes an operation/display unit 260 that is a touch panel type liquid crystal display device, a coin handling device 200, and a banknote handling device 210. The money handling apparatus 11 performs a dispensing process of dispensing money used to replenish each money handling apparatus 12 at the checkout counter, and a depositing process of depositing money that is proceeds from sales of the store collected from each money handling apparatus 12. In the depositing process, the coin handling device 200 recognizes and counts coins received in the depositing unit 211 and stores the coins inside the device 200, and the banknote handling device 210 recognizes and counts banknotes received in the depositing unit 221 and stores the banknotes inside the device 210. In the dispensing process, the coin handling device 200 discharges coins from a dispensing unit 212, and the banknote handling device 210 dispenses banknotes from a dispensing unit 222.

The money handling apparatus 12 includes an operation/display unit 360 that is a touch panel type liquid crystal display device, a coin handling device 300, and a banknote handling device 310. The money handling apparatus 12 functions as a settlement apparatus that settles monetary amounts of transactions with users who are customers of the store. The money handling apparatus 12 receives information on an item for sale at the store through the operation/display unit 360, and calculates a transaction amount. The customer deposits coins into the depositing unit 311 of the coin handling device 300, and deposits banknotes into the depositing unit 321 of the banknote handling device 310, to pay the transaction amount. The coin handling device 300 performs a depositing process in which the coins received in the depositing unit 311 are recognized, counted and stored inside the device 300, and the amount of the deposited coins is calculated. The banknote handling device 310 performs a depositing process in which the banknotes received in the depositing unit 321 are recognized, counted and stored inside the device 310, and the amount of the deposited banknotes is calculated. If the amount paid by the customer, i.e., the total amount of the deposited coins and the deposited banknotes, exceeds the transaction amount, the money handling apparatus 12 dispenses change to be returned to the customer. The coin handling device 300 performs a dispensing process of discharging coins, as part of the change, from the dispensing unit 312. The banknote handling device 310 performs a dispensing process of discharging banknotes, as part of the change, from the dispensing unit 322. The customer pays the transaction amount and receives change according to need, thereby completing the transaction.

Since the money handling apparatus 12 used as the settlement apparatus in the store and the money handling apparatus 11 used to dispense money for replenishing the money handling apparatus 12 and to deposit money collected from the money handling apparatus 12 are conventionally known, detailed description thereof will be omitted. The money to be handled in the money handling system 1 may be banknotes, coins, or both banknotes and coins, but the following description will continue with coins. To simplify the description, the coin handling device 200 of the money handling apparatus 11 installed in the back office of the store is referred to as a back apparatus 200, and the coin handling device 300 of the money handling apparatus 12 at the checkout counter located in a front area of the store is referred to as a front apparatus 300.

The management apparatus 3 includes an operation unit, a display, a control circuitry, and a memory. For example, a computer device is used as the management apparatus 3. The management apparatus 3 may not necessarily include the operation unit and the display, and may be remotely operated using an operation terminal. The management apparatus 3 may be a virtual server.

The management apparatus 3 stores and manages information on denominations and the number for each denomination of coins stored in the containers including the normal containers 145 and the replenishment containers 150 of the depositing apparatus 100. The management apparatus 3 stores and manages information on denominations and the number for each denomination of coins stored in the back apparatus 200 and the front apparatus 300. When a predetermined number of coins have been stored in the normal container 145 of the depositing apparatus 100, the management apparatus 3 performs a notification process of notifying the clerk that collection of coins stored in the normal container 145 is required. When the number of coins of the preset denominations stored in the replenishment container 150 reaches the respective preset numbers for each denomination, the management apparatus 3 performs a notification process of notifying the clerk of this fact. When the quantity of coins in the back apparatus 200 decreases and there is a denomination for which the number of coins has reached a predetermined number, the management apparatus 3 performs a notification process of notifying the clerk that there is a denomination for which replenishment is required in the back apparatus 200. Likewise, when there is a denomination for which replenishment is required in the front apparatus 300, the management apparatus 3 performs a notification process of notifying the clerk of this fact. For example, the management apparatus 3 performs the notification process by sending a notification including the content to be notified to the clerk, to a communication terminal such as a smartphone carried by the clerk. The notification process may be performed by displaying information on a predetermined display device and/or reproducing a notification sound using a device. The notification process of notifying the clerk that predetermined coins have been stored in the normal container 145 and the replenishment container 150 may be performed by the depositing apparatus 100. The notification process of notifying the clerk that there is a denomination for which replenishment is required in the back apparatus 200 and the front apparatus 300 may be performed by each apparatus 200, 300.

The depositing apparatus 100 receives coins deposited by a user who is a customer of the store and issues a coupon corresponding to the amount of the deposited coins. The coupon is a valuable medium that can be used instead of money in the store. The customer can use the amount of the coupon to pay the item price when purchasing the item sold in the store.

The customer starts a deposit transaction by operating the operation/display unit 160 that is a touch panel type liquid crystal display device. As shown in FIG. 2, the customer deposits coins from the depositing unit 111 of the depositing apparatus 100 (C1). The depositing apparatus 100 recognizes and counts the coins received in the depositing unit 111, and calculates the deposited amount. The depositing apparatus 100 recognizes the coins by the recognition unit 120, and stores the coins in the normal container 145 or the replenishment container 150 as described with reference to FIG. 1. The depositing apparatus 100 issues a coupon 175 corresponding to the deposited amount, from a coupon issuance unit 170 (C2). The depositing apparatus 100 issues a receipt 185 on which information on the deposited coins and information on the coupon are printed, from a receipt issuance unit 180 (C3). The customer receives the coupon 175 and the receipt 185 to complete the deposit transaction.

As shown in FIG. 2, the clerk dispenses coins from the back apparatus 200, and replenishes the front apparatus 300 with the coins (D1). The clerk dismounts the replenishment container 150 assigned to the back apparatus 200 from the depositing apparatus 100, and replenishes the back apparatus 200 with the coins in the replenishment container 150 (E1). The clerk dismounts the replenishment container 150 assigned to the front apparatus 300 from the depositing apparatus 100, and replenishes the front apparatus 300 with the coins in the replenishment container 150 (E2). After dismounting the replenishment container 150 from the storage unit 140, the clerk mounts an empty container in place of the dismounted container.

The housing of the depositing apparatus 100 is provided with a door 141 for taking out the normal containers 145 and the replenishment containers 150 from the storage unit 140 to the outside of the apparatus 100. The door 141 is usually locked. The clerk performs a predetermined operation on the operation/display unit 160 to unlock the door 141. The clerk can open the door 141 to take out the normal container 145 and the replenishment container 150 to the outside of the apparatus.

The depositing apparatus 100 can lock the normal containers 145 and the replenishment containers 150 to prevent these containers from being dismounted from the storage unit 140. When replenishment work for the back apparatus 200 is required, the depositing apparatus 100 unlocks only the replenishment container 150 assigned to the back apparatus 200 so that this replenishment container 150 can be dismounted from the storage unit 140. Likewise, when replenishment work for the front apparatus 300 is required, the depositing apparatus 100 unlocks only the replenishment container 150 that is assigned to the front apparatus 300 and is to be dismounted from the storage unit 140. When a cash-in-transit company collects the normal container 145 from the depositing apparatus 100, the normal container 145 to be collected by the cash-in-transit company is unlocked. Since the depositing apparatus 100 unlocks only the containers 145, 150 that need to be dismounted from the apparatus so that these containers can be taken out from the apparatus, the other containers 145, 150 are prevented from being taken out accidentally.

The normal container 145 and the replenishment container 150 are in the form of bags, and the depositing apparatus 100 can close the openings of each bag. Such a container in the form of a bag is sometimes referred to as a pouch. The method for closing the opening of the bag is not particularly limited, and a conventional method may be used. The opening of the bag may be closed by heat welding. Alternatively, an adhesive tape may be attached near the opening of the bag, and the opening may be adhesively closed by peeling off a release liner of the adhesive tape. Once the opening of the bag is closed, coins stored inside the bag cannot be taken out from the bag unless the bag is torn. For example, when it is desired to prevent fraudulent removal of coins from the normal container 145 and the replenishment container 150, the depositing apparatus 100 is set to close the openings of the bags of the normal container 145 and the replenishment container 150. Alternatively, the depositing apparatus 100 may be set to close the opening of the bag of the normal container 145 to be collected by the cash-in-transit company and not to close the opening of the bag of the replenishment container 150 to be used for the replenishment work in the store.

Next, the configuration and operation of each apparatus will be described. The configurations and operations, related to coin handling, of the back apparatus 200 and the front apparatus 300 are similar. To avoid redundancy, the following description will continue mainly with the back apparatus 200 as an example.

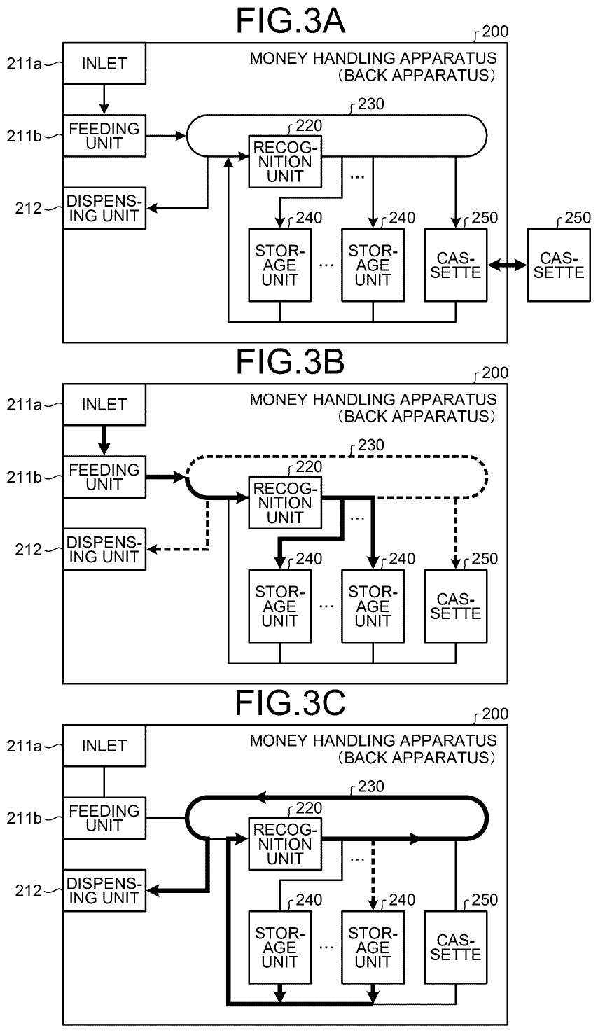

FIGS. 3A to 3C each show a schematic diagram illustrating an example of the configuration of the back apparatus 200. The back apparatus 200 includes the depositing unit 211 (211a, 211b), the dispensing unit 212, the recognition unit 220, a transport unit 230, storage units 240, and cassettes 250.

The depositing unit 211 includes an inlet 211a that can simultaneously receive a plurality of coins from outside the apparatus, and a feeding unit 211b that stores the plurality of coins received by the inlet 211a and feeds out the coins one by one to the transport path. The transport unit 230 transports coins along the transport path connecting the depositing unit 211, the dispensing unit 212, the recognition unit 220, the storage units 240, and the cassettes 250. The recognition unit 220 recognizes the coins being transported by the transport unit 230. The recognition unit 220 can recognize the denomination of each coin. The recognition unit 220 may recognize the authenticity of each coin.

Each storage unit 240 stores the coins transported along the transport path by the transport unit 230. The storage unit 240 can feed out the stored coins to the transport path. The number of the storage units 240 is not particularly limited.

Each cassette 250 is a cassette-type storage unit that is detachably mounted to the back apparatus 200. Like the storage unit 240, the cassette 250 stores the coins transported along the transport path by the transport unit 230 and feeds out the coins to the transport path. The cassette 250 is used for storing coins not to be used in the dispensing process and coins to be collected from the storage unit 240 to outside the apparatus 200. Therefore, the cassette 250 is sometimes referred to as a collection unit. When the storage unit 240 is full and cannot store a coin, the cassette 250 is used to store this coin, and therefore the cassette 250 is sometimes referred to as an overflow storage unit.

The dispensing unit 212 discharges the coins transported along the transport path by the transport unit 230 to outside the apparatus. The coins fed out from the storage unit 240 and the cassette 250 can be discharged from the dispensing unit 212. Of the coins deposited from the depositing unit 211, coins that cannot be stored in the apparatus, such as unrecognizable coins, may be discharged from the dispensing unit 212.

The back apparatus 200 can perform a plurality of types of coin handling including a depositing process and a dispensing process. In the depositing process, coins received in the inlet 211a of the depositing unit 211 are fed out to the transport path inside the apparatus by the feeding unit 211b, as indicated by solid-line arrows in FIG. 3B. The coins being transported along the transport path by the transport unit 230 are recognized by the recognition unit 220 and are respectively stored in the storage units 240 corresponding to the denominations of the coins. As indicated by broken-line arrows in FIG. 3B, coins that cannot be deposited may be discharged from the dispensing unit 212, and coins of denominations that cannot stored in the storage units 240 may be stored in the cassette 250. Coins obtained from the replenishment container 150 to replenish the back apparatus 200 are handled in the same way as those in the depositing process.

In the dispensing process, as indicated by solid-line arrows in FIG. 3C, coins to be dispensed are fed out from the storage units 240, transported by the transport unit 230, recognized by the recognition unit 22, and then discharged from the dispensing unit 212. There is a case where a denomination to be dispensed and a denomination not to be dispensed are stored in a mixed state in the storage unit 240, and coins of the denomination not to be dispensed are fed out from the storage unit 240. Such coins of the denomination not to be dispensed are returned to the storage unit 240 from which the coins have been fed out, as indicated by a broken-line arrow in FIG. 3C.

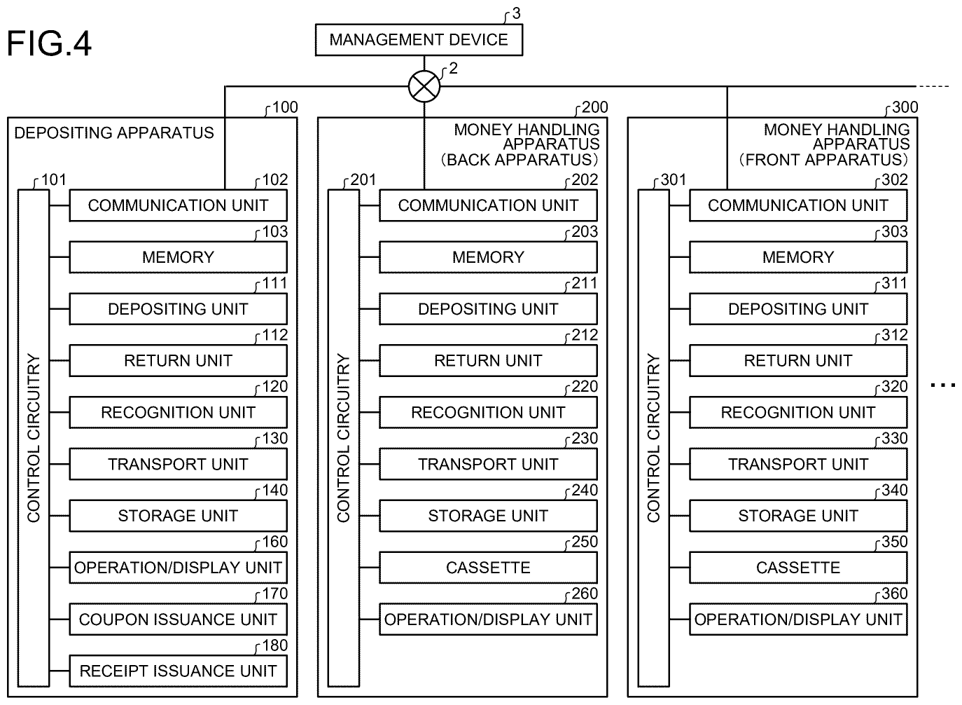

FIG. 4 is a block diagram showing an example of the configuration of the money handling system 1. The depositing apparatus 100 includes a control circuitry 101, a communication unit 102, and a memory 103 in addition to the components described with reference to FIG. 1 and FIG. 2. The communication unit 102 is used for communicating with external devices via the network 2. The memory 103 is a non-volatile storage device used for storing various kinds of information necessary for the operations of the depositing apparatus 100. A program corresponding to the control circuitry 101 is stored in advance in the memory 103 or a dedicated storage device. This program is executed by hardware such as a CPU, thereby realizing the functions and operations of the control circuitry 101. The control circuitry 101 can control the respective components of the depositing apparatus 100, based on information inputted/outputted through the operation/display unit 160, information transmitted/received via the communication unit 102, and information stored in the memory 103. Thus, the functions and operations of the depositing apparatus 100 according to the present embodiment are realized.

The back apparatus 200 includes a control circuitry 201, a communication unit 202, and a memory 203 in addition to the components described with reference to FIG. 2 and FIG. 3. The communication unit 202 is used for communicating with external devices via the network 2. The memory 203 is a non-volatile storage device used for storing various kinds of information necessary for the operation of the back apparatus 200. A program corresponding to the control circuitry 201 is stored in advance in the memory 203 or a dedicated storage device. This program is executed by hardware such as a CPU, thereby realizing the functions and operations of the control circuitry 201. The control circuitry 201 can control the respective components of the back apparatus 200, based on information inputted/outputted through the operation/display unit 260, information transmitted/received via the communication unit 202, and information stored in the memory 203. Thus, the functions and operations of the back apparatus 200 according to the present embodiment are realized.

As shown in FIG. 4, the front apparatus 300 has the same configuration as the back apparatus 200. The front apparatus 300 includes a control circuitry 301, a communication unit 302, a memory 303, a depositing unit 311 with an inlet and a feeding unit, a dispensing unit 312, a recognition unit 320, a transport unit 330, a storage unit 340, and a cassette 350. The front apparatus 300 can perform coin handling including a depositing process and a dispensing process.

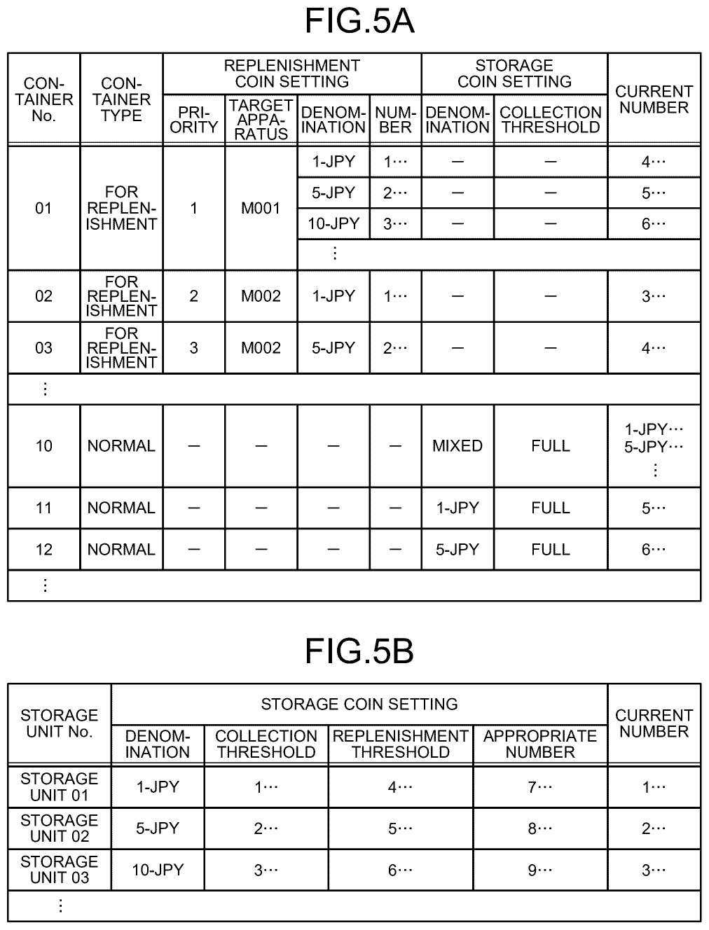

FIGS. 5A and 5B illustrate inventory information managed in the money handling system 1. FIG. 5A illustrates an example of inventory information of the depositing apparatus 100, and FIG. 5B illustrates an example of inventory information of the back apparatus 200 and the front apparatus 300.

The depositing apparatus 100 stores and manages the inventory information in the memory 103. The back apparatus 200 stores and manages the inventory information in the memory 203. The front apparatus 300 stores and manages the inventory information in the memory 303. The management apparatus 3 acquires the inventory information from the depositing apparatus 100, the back apparatus 200, and the front apparatus 300, and stores and manages the same in the memory of the management apparatus 3.

The depositing apparatus 100 stores coins in a plurality of containers 145, 150 that are mountable/dismountable with respect to the storage unit 140. In FIG. 5A, “container No.” is identification information for distinguishing the containers 145, 150 mounted to the storage unit 140 from each other, and “container type” indicates whether each container is used for the storage of coins for replenishment or the storage of normal coins. The same container mounted to the storage unit 140 can be used as both the normal container 145 and the replenishment container 150.

The depositing apparatus 100 stores coins in the replenishment containers 150 based on “replenishment coin setting”, and stores coins in the normal containers 145 based on “storage coin setting”, shown in FIG. 5A. The clerk can change the replenishment coin setting and the storage coin setting by operating the operation/display unit 160 of the depositing apparatus 100. The clerk can change the replenishment coin setting and the storage coin setting by using the operation unit and the display of the management apparatus 3 or a communication terminal such as a smartphone communicably connected to the management apparatus 3.

The “replenishment coin setting” includes the fields “priority”, “target apparatus”, “denomination”, and “number”. Under the field “target apparatus”, the apparatus No. (identification information) of a money handling apparatus to be replenished with coins stored in the replenishment container 150 is set. That is, the “target apparatus” indicates which one of the money handling apparatuses in the store is to be replenished with coins stored in the replenishment container 150. Under the field “target apparatus”, one of the apparatus numbers selected from the apparatus number of the back apparatus 200 and the apparatus numbers of the front apparatuses 300 is set.

The clerk can use the operation/display unit 160 of the depositing apparatus 100 or the communication terminal connected to the management apparatus 3 to display the inventory information shown in FIG. 5B and check the details of the settings. The correspondence between the target apparatus and each container No. of the normal containers 145 and the replenishment containers 150 allows the clerk to recognize the correspondence between the plurality of replenishment containers 150 and the plurality of money handling apparatuses.

Under the field “denomination” of the replenishment coin setting, denominations of coins to be stored in the replenishment container 150 are set. Under the field “number”, the number of coins to be stored for each denomination in the replenishment container 150 is set. In the example shown in FIG. 5A, the replenishment container 150 with container No. “01” is used to store a plurality of denominations of coins such as 1-JPY coins, 5-JPY coins, and 10-JPY coins according to the number of coins set for each denomination. The replenishment container 150 with container No. “02” is used to store only 1-JPY coins according to the set number. The replenishment container 150 with container No. “03” is used to store only 5-JPY coins according to the set number. As shown in these examples, the clerk can specify one or more denominations and the number of coins of each denomination to be stored in one replenishment container 150 so as to cause the depositing apparatus 100 to store coins according to the specified denominations and the numbers. When the coins set by the clerk have been stored in the replenishment container 150 and the storage of the specified coins is finished, the depositing apparatus 100 performs a notification process of notifying the clerk of this fact.

Under the field “priority” of the replenishment coin setting, the priorities of the replenishment containers 150 for selecting one container when storing a coin are set. For example, if coins deposited by the customer include a 1-JPY coin, “1-JPY coin” is set under the field “denomination” for the replenishment container 150 with container No. “01” and the replenishment container 150 with container No. “02”. In this case, the 1-JPY coin is stored in the replenishment container 150 with container No. “01” because this container has a higher priority than that of the container 150 with container No. “02”. After the number of 1-JPY coins stored in the replenishment container 150 with container No. “01” reaches the predetermined number set for this container 150, subsequent 1-JPY coins will be stored in the replenishment container 150 with container No. “02” until the number of stored 1-JPY coins reaches the predetermined number set for this container 150.

The “storage coin setting” includes the fields “denomination” and “collection threshold”. Under the field “denomination” of the storage coin setting, denominations of coins to be stored in the normal container 145 are set. For example, the initial setting of “denomination” is “mixed”, and if the clerk does not specify a denomination in this field, coins of any denomination will be stored in the normal container 145. The clerk can set a denomination for the normal container 145 under the field “denomination”. In the example shown in FIG. 5A, the normal container 145 with container No. “10” is set to store coins of all denominations in a mixed state, the normal container 145 with container No. “11” is set to store 1-JPY coins, and the normal container 145 with container No. “12” is set to store 5-JPY coins.

Under the field “collection threshold” of the storage coin setting, the number of coins that is a criterion for determining whether collection is required, is set. When the number of coins stored in the normal container 145 has reached the collection threshold, the depositing apparatus 100 determines that collection is required for this container and performs a notification process for the clerk. For example, the initial setting of “collection threshold” is “full”, and if the clerk does not specify the number in this field, coins will be stored in the normal container 145 until the depositing apparatus 100 determines that the normal container 145 is full. The clerk can set the number of coins under the field “collection threshold” to change, for each normal container 145, the number of coins for which the depositing apparatus 100 determines that the collection is required.

Under the field “current number”, the number of coins currently stored in each of the normal containers 145 and the replenishment containers 150 is registered. When the customer has performed a deposit transaction with the depositing apparatus 100 and coins are stored in the replenishment container 150 or the normal container 145, the depositing apparatus 100 updates the number registered under the field “current number”.

In the example shown in FIG. 5A, since the denomination setting of the normal container 145 with container No. “10” is “mixed”, all coins are stored in the normal container 145 regardless of the denomination. Alternatively, there is a case where the clerk sets a plurality of denominations and coins of the set denominations are stored in a mixed state in the normal container 145. When one normal container 145 is used for storing coins in the mixed state, the depositing apparatus 100 stores coins regardless of the number of coins for each denomination. Specifically, for example, if the clerk sets the normal container 145 to store 1-JPY coins and 5-JPY coins, the depositing apparatus 100 stores 1-JPY coins and 5-JPY coins until the normal container 145 becomes full of coins, regardless of the number of 1-JPY coins and the number of 5-JPY coins stored in the normal container 145. Therefore, the number of 1-JPY coins and the number of 5-JPY coins stored in the full-state normal container 145 vary depending on the deposit transactions performed by customers. On the other hand, when the clerk sets the replenishment container 150 to store 1-JPY coins and 5-JPY coins, the number of 1-JPY coins and the number of 5-JPY coins to be stored therein are also set at the same time. Therefore, the depositing apparatus 100 stores 1-JPY coins in the replenishment container 150 until the number of the stored 1-JPY coins reaches the set number, and after that, the depositing apparatus 100 does not store any more 1-JPY coins in the replenishment container 150 even if the replenishment container 150 is not full. Also, the depositing apparatus 100 stores 5-JPY coins in the replenishment container 150 until the number of the stored 5-JPY coins reaches the set number without checking whether the replenishment container 150 is full. Thus, the depositing apparatus 100 stores coins in the replenishment container 150 in a different way from that of the normal container 145.

FIG. 5B illustrates inventory information of the back apparatus 200. In FIG. 5B, “storage unit No.” is identification information for distinguishing the plurality of storage units 240 included in the back apparatus 200 from each other.

The field “storage coin setting” includes the fields “denomination”, “collection threshold”, “replenishment threshold”, and “appropriate number”. Under the field “denomination”, a denomination of coins to be stored in the storage unit 240 is set. In the example shown in FIG. 5B, the storage unit 240 with storage unit No. “01” is used to store 1-JPY coins, the storage unit 240 with storage unit No. “02” is used to store 5-JPY coins, and the storage unit 240 with storage unit No. “03” is used to store 10-JPY coins.

Under the field “collection threshold”, the number of coins that is a criterion for determining whether collection of coins from the storage unit 240 is required, is set. When the number of coins stored in the storage unit 240 has increased and reached the collection threshold, the back apparatus 200 determines that the collection is required and performs a notification process for the clerk. Under the field “replenishment threshold”, the number of coins that is a criterion for determining whether replenishment of the storage unit 240 with coins is required, is set. When the number of coins stored in the storage unit 240 has decreased and reached the replenishment threshold, the back apparatus 200 determines that the replenishment is required and performs a notification process for the clerk.

Under the field “appropriate number”, the number of coins that are preferably stored in the storage unit 240 is set. The appropriate number is set to a number that is less than the collection threshold and more than the replenishment threshold. The appropriate number is set such that depositing processes can be performed and coins can be stored during these processes, and dispensing processes can be performed and coins can be dispensed during these processes. For example, the number of coins of a change fund, which is prepared for change before the store opens for business, is set as the appropriate number.

When performing the replenishment work, the apparatus 200 is replenished with coins until the number of coins in the storage unit 240 reaches the appropriate number. For example, a difference between the appropriate number and the replenishment threshold is set as the number of coins to be stored in the replenishment container 150 of the depositing apparatus 100. Specifically, for example, if the appropriate number of the storage unit 240 is 800 and the replenishment threshold is 200, in order to obtain 600 (=appropriate number “800”—replenishment threshold “200”) coins for the replenishment to be performed when the number of coins in this storage unit 240 has reached the replenishment threshold, the number of coins to be stored in the replenishment container 150 is set to 600.

Under the field “current number”, the number of coins currently stored in each of the storage units 240 and the cassettes 250 is registered. Each time the depositing process and the dispensing process are performed in the back apparatus 200, the back apparatus 200 updates the number of coins under the field “current number”.

The cassette 250 is used for storing coins that cannot be stored in the storage unit 240, coins collected from the storage unit 240, and coins for replenishing the storage unit 240. Therefore, denominations of coins to be stored in the cassette 250 and a replenishment threshold for the cassette 250 are not set, but the back apparatus 200 manages inventory information of the cassette 250 including denominations and the number for each denomination of coins currently stored in the cassette 250, in the same way as that for the storage unit 240.

The front apparatus 300 manages inventory information including denominations and the number for each denomination of coins stored in each of the storage units 340 and the cassettes 350, in the same way as that for the back apparatus 200. The inventory information of the front apparatus 300 includes “denomination”, “collection threshold”, “replenishment threshold”, and “current number” of coins of each storage unit 340, similarly to those shown in FIG. 5B. The front apparatus 300 manages the inventory information of the cassette 350 including denominations and the number for each denomination of coins currently stored in the cassette 350.

The management apparatus 3 stores the inventory information of the depositing apparatus 100, the inventory information of the back apparatus 200, and the inventory information of the front apparatus 300, as shown in FIGS. 5A and 5B. The management apparatus 3 stores the inventory information of the cassette 250 of the back apparatus 200 and the inventory information of the cassette 350 of the front apparatus 300.

When coins of preset denominations have been stored in the replenishment container 150 of the depositing apparatus 100 and the number of stored coins of each denomination has reached its preset number, the management apparatus 30 performs a notification process of notifying the clerk of this fact. When there is a storage unit 240 in which the number of coins has reached its replenishment threshold in the back apparatus 200, the management apparatus 30 performs a notification process of notifying the clerk of this fact. When there is a storage unit 340 in which the number of coins has reached its replenishment threshold in the front apparatus 300, the management apparatus 30 performs a notification process of notifying the clerk of this fact.

Upon receiving the notification that the preset number of coins of the preset denominations has been stored in the replenishment container 150, the clerk collects the replenishment container 150 from the depositing apparatus 100. The clerk replenishes the back apparatus 200 or the front apparatus 300, whose apparatus number is set under the field “target apparatus” corresponding to the collected replenishment container 150 in FIG. 5A, with the coins obtained from this container 150. In the replenishment container assigned to the back apparatus 200, coins for replenishing the back apparatus 200 when the back apparatus 200 requires replenishment are stored. In the replenishment container 150 assigned to the front apparatus 300, coins for replenishing the front apparatus 300 when the front apparatus 300 requires replenishment are stored. Upon receiving the notification that the storage unit 240 in the back apparatus 200 requires replenishment, the clerk can finish the replenishment work simply by depositing the coins in the replenishment container 150 assigned to the back apparatus 200 into the back apparatus 200. Likewise, upon receiving the notification that the storage unit 340 in the front apparatus 300 requires replenishment, the clerk can finish the replenishment work simply by depositing the coins in the replenishment container 150 assigned to the front apparatus 300 into the front apparatus 300.

Specifically, for example, if it has been set that the back apparatus 200 is replenished with 600 1-JPY coins when the number of 1-JPY coins in the storage unit 240 in the back apparatus 200 has reached 200 set as the replenishment threshold, the clerk assigns one of the replenishment containers 150 in the depositing apparatus 100 to the back apparatus 200 and sets the replenishment container 150 to store 600 1-JPY coins. Upon being notified that 600 1-JPY coins have been stored in the replenishment container 150, the clerk dismounts the replenishment container 150 from the depositing apparatus 100 and mounts an empty replenishment container 150 in place of the dismounted container 150. Thus, the replenishment container 150 containing 600 1-JPY coins is prepared for the back apparatus 200. Upon being notified that the back apparatus 200 requires replenishment with 1-JPY coins, the clerk can finish the replenishment work by replenishing the back apparatus 200 with 600 1-JPY coins obtained from the replenishment container 150. Similarly, for other denominations, coins for replenishment can be prepared simply by setting the denomination and number of coins of that denomination to be stored in the replenishment container 150. Even if the number of coins for replenishment differs among denominations, the clerk only needs to change the number of coins set for the replenishment container 150. Since the front apparatus 300 is smaller than the back apparatus 200, the number of coins for replenishment in the front apparatus 300 may differ from that for the back apparatus 200, even for the same denomination. In this case, the clerk only needs to change the setting of the number of coins to be stored in the replenishment container 150 assigned to the front apparatus 300.

Even if all the replenishment containers 150 in the depositing apparatus 100 are each filled with the set number of coins of the set denomination and the replenishment containers 150 are no longer able to store coins, the depositing apparatus 100 can store coins in the normal containers 145. Therefore, the clerk has to do is to replace the replenishment container 150 that is full of coins with an empty container 150 before the normal containers 145 become full of coins.

In a case where a plurality of denominations and the number for each denomination of coins to be stored in the back apparatus 200 are set for one replenishment container 150, it may not be possible to replenish the back apparatus 200 with all the coins stored in the replenishment container 150 when the back apparatus 200 needs to be replenished with coins of one denomination.

For example, it is assumed that the replenishment container 150 assigned to the back apparatus 200 is set to store 600 1-JPY coins and 600 5-JPY coins, and 600 1-JPY coins and 600 5-JPY coins have already been stored in the replenishment container 150.

There is a case where the number of 1-JPY coins in the back apparatus 200 has reached the replenishment threshold and replenishment with 600 1-JPY coins is required, but many 5-JPY coins remain in the back apparatus 200. Supposing that the number of 5-JPY coins required to bring the current number of 5-JPY coins in the back apparatus 200 to the appropriate number is 200. In this case, of the coins stored in the replenishment container 150, 400 5-JPY coins (=600 coins in replenishment container—200 coins to be stored in back apparatus) become surplus coins and cannot be stored in the back apparatus 200.

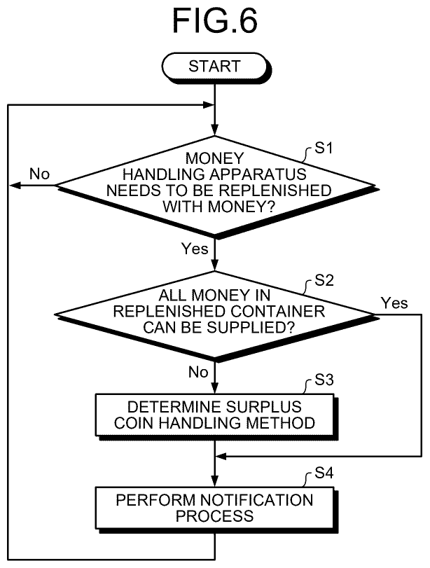

When it is not possible to replenish the back apparatus 200 with all the coins in the replenishment container 150, the management apparatus 3 can determine a method for handling the surplus coins that cannot be used for the replenishment. FIG. 6 is a flowchart showing the flow of the process performed by the management apparatus 3.

The management apparatus 3 is monitoring, based on the inventory information, whether the money handling apparatus, i.e., the back apparatus 200, needs to be replenished with money (step S1; No). Each time the “current number” shown in FIG. 5B is updated in the back apparatus 200, the management apparatus 3 determines whether there is a storage unit 240 in which the current number of coins is equal to or less than the replenishment threshold.

When there is a storage unit 240 in which the current number of coins becomes equal to or less than the replenishment threshold, the management apparatus 3 determines that the back apparatus 200 needs to be replenished with coins (step S1; Yes). Based on the inventory information of the depositing apparatus 100, the management apparatus 3 specifies denominations and the number for each denomination of coins stored in the replenishment container 150 assigned to the back apparatus 200. Based on the inventory information of the back apparatus 200, the management apparatus 3 determines whether all the coins stored in the replenishment container 150 can be used to replenish the back apparatus 200, i.e., whether all the coins can be stored in the storage unit 240 (step S2).

When all the coins in the replenishment container 150 can be stored in the back apparatus 200 (step S2; Yes), the management apparatus 3 performs a notification process (step S4). For example, the clerk is notified that the back apparatus 200 needs to be replenished with money, and of the container No. of the replenishment container 150 to be dismounted from the depositing apparatus 100. The clerk performs replenishment work in which the replenishment container 150 of the notified container No. is dismounted from the depositing apparatus 100 and the back apparatus 200 is replenished with coins in the replenishment container 150.

If it is not possible to store all the coins in the replenishment container 150 into the back apparatus 200 (step S2; No), the management apparatus 3 determines a method for handling the surplus coins that cannot be stored in the back apparatus 200 (step S3). When the surplus coin handling method has been determined, the management apparatus 3 performs a notification process (step S4). The clerk is notified that the back apparatus 200 needs to be replenished with money, and of the container No. of the replenishment container 150 to be dismounted from the depositing apparatus 100. In addition, the clerk is notified of the surplus coin handling method. The clerk dismounts the replenishment container 150 of the notified container No. from the depositing apparatus 100, and handles the surplus coins by the notified method when performing replenishment work for the back apparatus 200.

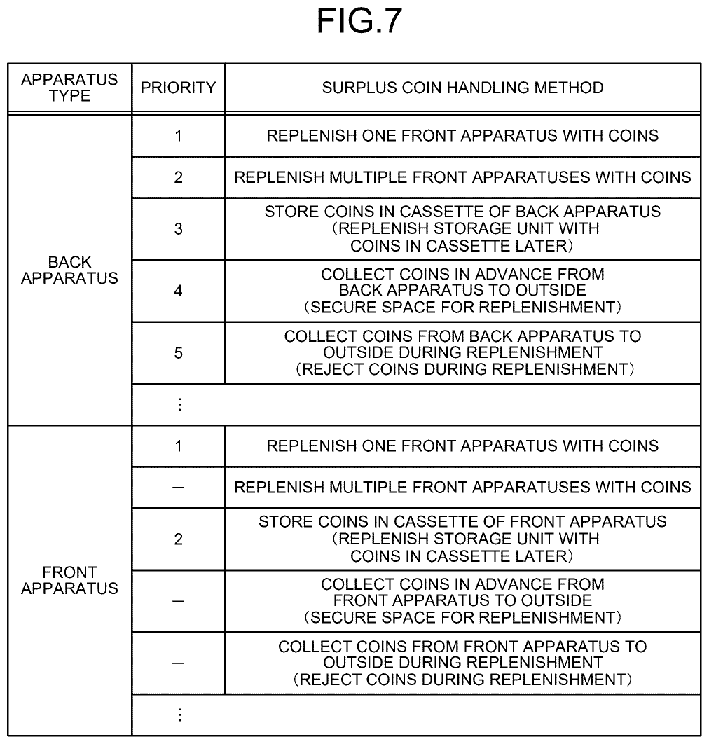

FIG. 7 illustrates surplus coin handling methods to be determined by the management apparatus 3. As shown in FIG. 7, the management apparatus 3 is provided with a plurality of types of surplus coin handling methods according to the apparatus types of the back apparatus 200 and the front apparatus 300. The plurality of handling methods are given priorities, and the management apparatus 3 determines whether surplus coins can be handled, in order from the handling method with the highest priority. The clerk can change the surplus coin handling method and the priority order by using the operation unit and the display of the management apparatus 3 or a communication terminal such as a smartphone communicably connected to the management apparatus 3.

The management apparatus 3 determines whether the surplus coins can be handled by the handling method of the back apparatus 200 with priority “1” shown in FIG. 7. In the above described example, if 400 5-JPY coins become surplus coins when the back apparatus 200 is replenished with coins, the management apparatus 3 searches for one front apparatus 300 capable of storing the 400 5-JPY coins, based on the inventory information of each front apparatus 300. The management apparatus 3 calculates, for each front apparatus 300, the number of 5-JPY coins that can be stored in the front apparatus 300, by subtracting the current number from the appropriate number of 5-JPY coins, and searches for a front apparatus 300 in which 400 or more 5-JPY coins can be stored. If such a front apparatus 300 has been found, the management apparatus 3 performs a notification process for the clerk.

For example, information indicating that there are surplus coins and work for securing a storage space for these surplus coins in the back apparatus 200 is required, is displayed on the screen of the communication terminal carried by the clerk, in addition to the container No. of the replenishment container 150 that is assigned to the back apparatus 200 and is to be dismounted from the depositing apparatus 100. In addition, denominations and the number for each denomination of the surplus coins, information that instructs the clerk to perform replenishment work for replenishing the front apparatus 300 with coins equivalent to the surplus coins and obtained from the back apparatus 200, and the apparatus No. of that front apparatus 300 searched by the management apparatus 3, are displayed.

Upon receiving the notification, the clerk performs a dispensing process of dispensing 400 5-JPY coins from the back apparatus 200, and replenishes the front apparatus 300 of the specified apparatus No. with the dispensed coins. After all the coins in the replenishment container 150 are thus made storable in the back apparatus 200, the back apparatus 200 is replenished with the coins in the replenishment container 150 dismounted from the depositing apparatus 100. The clerk inserts all the coins stored in the replenishment container 150 into the depositing unit 211 of the back apparatus 200, thereby replenishing the back apparatus 200 with all the coins.

If the surplus coins cannot be handled by the handling method with priority “1” shown in FIG. 7, the management apparatus 3 determines whether the surplus coins can be handled by the handling method with priority “2”. In this way, the management apparatus 3 determines whether the surplus coin handling methods are executable, in the order of the priorities set as shown in FIG. 7, and notifies the clerk of the executable surplus coin handling method.

The handling method for the back apparatus 200 with priority “2” shown in FIG. 7 is a process of dividing the surplus coins and storing them in a plurality of front apparatuses 300. For example, when there is no front apparatus 300 capable of storing 400 5-JPY coins as the surplus coins but there are two front apparatuses 300 each capable of storing 200 5-JPY coins, the management apparatus 3 determines that this handling method is executable. In this case, the management apparatus 3 performs a notification process of notifying the clerk of the apparatus Nos. of these two front apparatuses 300 and instructing the clerk to replenish each of the two front apparatuses 300 with 200 5-JPY coins dispensed from the back apparatus 200 and then replenish the back apparatus 200 with the coins in the replenishment container 150.

The handling method of the back apparatus 200 with priority “3” shown in FIG. 7 is a process of storing the surplus coins in the cassette 250 of the back apparatus 200. For example, if the back apparatus 200 is set such that coins that cannot be stored therein during the replenishment work are stored in the cassette 250 and the cassette 250 is capable of storing the surplus coins, the management apparatus 3 determines that this handling method is executable. In this case, the management apparatus 3 performs a notification process of notifying the clerk that the surplus coins generated during the replenishment work will be stored in the cassette 250 of the back apparatus 200.

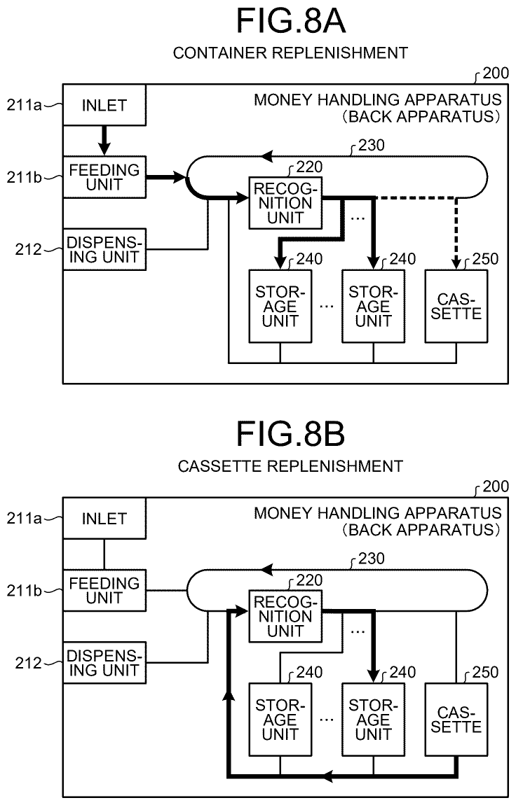

FIG. 8 illustrates an example of surplus coin handling. When coins in the replenishment container 150 are inserted from the inlet 211a of the back apparatus 200, these coins are fed out from the feeding unit 211b, recognized by the recognition unit 220, and stored in the storage unit 240 as indicated by solid-line arrows in FIG. 8A. Surplus coins that cannot be stored in the storage unit 240 are stored in the cassette 250 as indicated by a broken-line arrow in FIG. 8A.

When the surplus coins are stored in the cassette 250, the back apparatus 200 replenishes the storage unit 240 with the surplus coins at a predetermined timing. For example, when the number of coins in the storage unit 240 decreases due to a dispensing process or the like performed by the back apparatus 200, the back apparatus 200 feeds out the surplus coins from the cassette 250, recognizes the coins by the recognition unit 220, and replenishes the storage unit 240 with the coins as indicated by solid-line arrows in FIG. 8B. A coin that is not to be stored in the storage unit 240 may be stored in the cassette 250. In this case, such a coin is found based on recognition result by the recognition unit 220 and then returned to the cassette 250.

The handling method for the back apparatus 200 with priority “4” shown in FIG. 7 is a handling method in which coins are collected from the back apparatus 200 to the outside in order to secure a storage space for the surplus coins in the storage unit 240 before starting the replenishment. In this case, the management apparatus 3 performs a notification process of instructing the clerk to perform collection work for collecting coins equivalent to the surplus coins from the back apparatus 200 to the outside in advance and then replenishing the back apparatus 200 with the coins in the replenishment container 150. Upon receiving the notification, the clerk discharges coins of the same denomination as the surplus coins in the same number as the number of the surplus coins from the storage unit 240 of the back apparatus 200 to the outside in order to collect these coins, and then replenishes the back apparatus 200 with the coins in the replenishment container 150. As a result, all the coins in the replenishment container 150 are stored in the storage unit 240 of the back apparatus 200, thereby completing the replenishment work. In this case, the coins collected from the back apparatus 200 to the outside are managed in the back office until a cash-in-transit company comes to collect them, for example.

The handling method for the back apparatus 200 with priority “5” shown in FIG. 7 is a process of discharging the surplus coins from the dispensing unit 212 of the back apparatus 200 during the replenishment to collect the surplus coins. In this case, the management apparatus 3 performs a notification process of notifying the clerk that the surplus coins will be discharged from the dispensing unit 212 while the back apparatus 200 is replenished with coins. Upon receiving the notification, the clerk performs the replenishment work, and the surplus coins are discharged from the dispensing unit 212. The clerk manages the surplus coins discharged from the dispensing unit 212 during the replenishment work, in the back office until the cash-in-transit company comes to collect them, for example. Since the process with priority “4” is not determined to be inexecutable, the process with priority “5” is not executed in the setting shown in FIG. 7. For example, if the collection of the surplus coins during the replenishment is preferable to the collection of them in advance, the priorities “4” and “5” may be exchanged.

The process shown in FIG. 6 is also performed for the front apparatus 300. If surplus coins are generated during the replenishment for the front apparatus 300, the management apparatus 3 determines a surplus coin handling method using the priorities shown in FIG. 7. The mark “-” under the field “priority” indicates that the corresponding process is not to be subjected to determination, i.e., is not to be performed for the front apparatus 300. Thus, the clerk can set processes to be executed and processes not to be executed.

For example, in a case where the front apparatus 300 is replenished with coins in the replenishment container 150 through the depositing unit 311, if surplus coins cannot be stored in the storage unit 340 but can be stored in another front apparatus 300, the management apparatus 3 notifies the clerk that surplus coins generated during the replenishment work need to be used to replenish the other front apparatus 300 and notifies the clerk of the apparatus No. of this front apparatus 300. The clerk replenishes the target front apparatus 300 with the coins in the replenishment container 150 through the depositing unit 311. The surplus coins are discharged from the dispensing unit 312 of the target front apparatus 300. The clerk replenishes the other front apparatus 300 notified from the management apparatus 3 with the coins discharged from the dispensing unit 312 of the target apparatus 300.

When the management apparatus 3 has determined to store the surplus coins in the cassette 350 of the front apparatus 300, the clerk replenishes the target front apparatus 300 with the coins in the replenishment container 150 through the depositing unit 311. The surplus coins are stored in the cassette 350 of the target front apparatus 300, similarly to the handling in the back apparatus 200 shown in FIG. 8A. Thereafter, when this front apparatus 300 performs a dispensing process or the like and the surplus coins in the cassette 350 can thereby be stored in the storage unit 340, the surplus coins are fed out from the cassette 350, recognized by the recognition unit 320, and used to replenish the storage unit 340, similarly to the handling in the back apparatus 200 shown in FIG. 8B.

In the present embodiment, the denominations and the number for each denomination of coins to be stored in the replenishment container 150 of the depositing apparatus 100 are manually set in advance by the clerk, but may be automatically set based on the inventory information of the back apparatus 200 and the front apparatus 300. The management apparatus 3 may determine the denominations and the number for each denomination of coins for replenishing the back apparatus 200, based on the inventory information of the back apparatus 200, and may set them for the replenishment container 150 assigned to the back apparatus 200.

For example, based on the inventory information shown in FIG. 5B, the management apparatus 3 may calculate the number of coins for replenishment by subtracting the replenishment threshold from the appropriate number for each storage unit 240 of the back apparatus 200, and may set the denomination and the number of coins for replenishment calculated for each storage unit 240, as the denomination and the number of coins to be stored in the corresponding replenishment container 150. Similarly, for the front apparatus 300, based on the inventory information of the front apparatus 300, the management apparatus 3 may automatically set denominations and the number for each denomination of coins to be stored in the replenishment container 150 assigned to the front apparatus 300.

The management apparatus 3 may set the number of coins obtained by subtracting the current number from the appropriate number shown in FIG. 5B, under the field “number” for the replenishment container 150. If the set number of coins to be stored in the replenishment container 150 is changed in real time to the current number in the inventory information corresponding to the apparatuses 200, 300 to be replenished with these coins, the number of surplus coins that cannot be stored in the storage unit 240, 340 during the replenishment work can be reduced.

The management apparatus 3 may record the history of the inventory information of the back apparatus 200, predict denominations and the number for each denomination of coins with which the back apparatus 200 needs to be replenished, based on transition of past inventory amounts, and make the setting for the replenishment container 150 based on the prediction result. For example, if it is predicted from the history that the back apparatus 200 will be short of 300 1-JPY coins, the management apparatus 3 may set the replenishment container 150 assigned to the back apparatus 200 to store 300 1-JPY coins. For example, the prediction may be made based on the history of a predetermined period such as a week or a month in the past. Similarly, for the front apparatus 300, the management apparatus 3 may automatically change the setting of the replenishment container 150 assigned to the front apparatus 300, based on transition of the past inventory amounts of the front apparatus 300.

In the present embodiment, the normal container 145 and the replenishment container 150 of the depositing apparatus 100 are bag-type containers, but at least one of the normal container 145 and the replenishment container 150 may be a cassette-type container. For example, even in a case where a cassette-type container that is mountable/dismountable with respect to the depositing apparatus 100, the back apparatus 200 and the front apparatus 300 is used as the replenishment container 150, the replenishment work can be performed as described above.

The cassette-type replenishment container 150 may include a memory device, and the depositing apparatus 100, the back apparatus 200, and the front apparatus 300 may include a reading device for reading/writing information from/in the memory device. If the back apparatus 200 is configured to function as the management apparatus 3 by exchanging the inventory information and the like via the memory devices of the replenishment containers 150, the replenishment work can be performed as described above even in an environment where the network 2 and the management apparatus 3 cannot be used.

A money handling system according to the present disclosure includes: a money handling apparatus that performs a dispensing process to discharge money stored in a storage unit to outside the apparatus; a depositing apparatus that receives deposited money, stores money of predetermined denominations for which a quantity of money of each denomination is set in advance for replenishing the money handling apparatus in a replenishment container, and stores money other than the predetermined money for replenishing the money handling apparatus in a normal container; and a management apparatus that notifies information on replenishment work for replenishing the money handling apparatus with money in the replenishment container. The depositing apparatus may receive money deposited by a customer of a store, and the management apparatus may notify a clerk of the information on the replenishment work. The management apparatus may notify information on the replenishment container and information on a money handling apparatus to be replenished with money in the replenishment container. The notification may be performed by displaying the related information on a display of the management apparatus, a display of the depositing apparatus, a display of the money handling apparatus, or the like. The notification may be performed by transmitting a message from the management apparatus to an external device such as a mobile terminal.

In the above configuration, in a case where the deposited money is storable in both the replenishment container and the normal container, the depositing apparatus may store the deposited money in the replenishment container until money of one or more predetermined denominations is stored therein in the quantity for each denomination set in advance.

In the above configuration, the depositing apparatus may include a first replenishment container to store money for replenishing a first money handling apparatus and a second replenishment container to store money for replenishing a second money handling apparatus. In a case where the deposited money is storable in both the first replenishment container and the second replenishment container, the depositing apparatus may determine a storage destination of the deposited money, based on priorities set in advance for the first replenishment container and the second replenishment container.

In the above configuration, when the quantity of money stored in the money handling apparatus has reached a predetermined threshold, the management apparatus may notify that the replenishment work is required for the money handling apparatus.

In the above configuration, the management apparatus may notify to dismount the replenishment container from the depositing apparatus, and to replenish the money handling apparatus with money stored in the replenishment container.

In the above configuration, the money handling apparatus may further include a collection unit that stores money not to be used for the dispensing process. In a case where there is surplus money not storable in the storage unit when the money handling apparatus is replenished with money stored in the replenishment container, the surplus money may be stored in the collection unit. The management apparatus may notify that the surplus money is stored in the collection unit.

In the above configuration, in a case where there is surplus money not storable in the storage unit when the money handling apparatus is replenished with money stored in the replenishment container, the management apparatus may notify denominations and the number for each denomination of the surplus money, and that money equivalent to the surplus money needs to be transferred from the money handling apparatus to another money handling apparatus.

In the above configuration, in a case where there is surplus money not storable in the storage unit when the money handling apparatus is replenished with money stored in the replenishment container, the management apparatus may perform determination as to whether there is a unit capable of storing the surplus money other than the storage unit in the money handling apparatus, and determination as to whether there is a money handling apparatus capable of storing the surplus money other than the money handling apparatus, in a predetermined priority order, determine a method for handling the surplus money, and notify a result of the determination.

In the above configuration, the replenishment container may be configured not to feed out stored money therefrom.

In the above configuration, the replenishment container may be a bag-type container capable of storing money inside a bag body.

In the above configuration, the depositing apparatus may issue a coupon corresponding to an amount of the deposited money.

In the above configuration, the money handling apparatus may include a plurality of storage units to store money by denomination.

In the above configuration, the management apparatus may notify the information on the replenishment work when the money of predetermined denomination for which a quantity of money of each denomination is set in advance is stored in the replenishment container.

A money handling method according to the present disclosure is a method performed by a money handling system, and the method includes: receiving money deposited in a depositing apparatus including a replenishment container and a normal container, storing money of predetermined denominations for which a quantity of money of each denomination is set in advance for replenishing a money handling apparatus in the replenishment container, and storing money other than the predetermined money for replenishing the money handling apparatus in the normal container; and notifying information on replenishment work for replenishing the predetermined money handling apparatus with money in the replenishment container.

A money depositing apparatus according to the present disclosure includes: a depositing unit configured to receive money; a transport unit configured to transport the money received in the depositing unit; a recognition unit configured to recognize the money transported by the transport unit; a replenishment container and a normal container configured to store the money recognized by the recognition unit; and a control circuitry configured to store money of predetermined denominations for which a quantity of money of each denomination is set in advance for replenishing a money handling apparatus in the replenishment container, and store money other than the money for replenishing the money handling apparatus in the normal container.

According to the money depositing apparatus, the money handling system, and the money handling method of the present disclosure, a store clerk can easily perform replenishment work in which money is transferred between a plurality of apparatuses and a destination apparatus is replenished with the transferred money, thereby improving convenience for the store clerk.

The present embodiment shows a configuration in which the money handling system 1 includes the management apparatus 3, the depositing apparatus 100, and the plurality of money handling apparatuses 11, 12. However, the configuration is conceptually functional, and the configuration of the money handling system 1 may not necessarily be physically limited thereto. For example, in the example shown in FIG. 2, the money handling apparatus 11 may realize a part or all of the functions and operations of the management apparatus 3. Distributed or integrated forms of each device are not limited to the above- described forms, and all or some of the forms may be distributed or integrated functionally or physically in any unit depending on various loads, use statuses, or the like.

As described above, according to the money depositing apparatus, the money handling system, and the money handling method of the present embodiment, money that a customer has deposited in a depositing apparatus can be used for replenishing other money handling apparatuses. Since the depositing apparatus can be set such that denominations and the quantity for each denomination of money required in the money handling apparatus are stored in a replenishment container, the clerk only needs to put, into a depositing unit of the money handling apparatus, money that has been stored in the replenishment container dismounted from the depositing apparatus. Even if surplus coins that cannot be stored in the money handling apparatus are generated during replenishment work, since a method for handling the surplus coins has been determined and notified to the clerk, the clerk only needs to perform the work according to the notification. This allows the clerk to easily perform the replenishment work.

1. A money handling system comprising:
a money handling apparatus that performs a dispensing process to discharge money stored in a storage unit to outside the money handling apparatus;
a depositing apparatus that receives deposited money, stores money of predetermined denominations for which a quantity of the money of each denomination is set in advance for replenishing the money handling apparatus in a replenishment container, and stores money other than the money for replenishing the money handling apparatus in a normal container; and
a management apparatus that notifies information on replenishment work for replenishing the money handling apparatus with money in the replenishment container.

2. The money handling system according to claim 1, wherein in a case where the deposited money is storable in both the replenishment container and the normal container, the depositing apparatus stores the deposited money in the replenishment container until money of one or more predetermined denominations is stored therein in the quantity for each denomination set in advance.

3. The money handling system according to claim 2, wherein the depositing apparatus includes a first replenishment container to store money for replenishing a first money handling apparatus and a second replenishment container to store money for replenishing a second money handling apparatus, and
in a case where the deposited money is storable in both the first replenishment container and the second replenishment container, the depositing apparatus determines a storage destination of the deposited money, based on priorities set in advance for the first replenishment container and the second replenishment container.

4. The money handling system according to claim 1, wherein when the quantity of money stored in the money handling apparatus has reached a predetermined threshold, the management apparatus notifies that the replenishment work is required for the money handling apparatus.

5. The money handling system according to claim 1, wherein the management apparatus notifies to dismount the replenishment container from the depositing apparatus and to replenish the money handling apparatus with money stored in the replenishment container.

6. The money handling system according to claim 1, wherein the money handling apparatus further includes a collection unit that stores money not to be used for the dispensing process, and
in a case where there is surplus money not storable in the storage unit when the money handling apparatus is replenished with money stored in the replenishment container, the management apparatus notifies that the surplus money is stored in the collection unit.

7. The money handling system according to claim 1, wherein
in a case where there is surplus money not storable in the storage unit when the money handling apparatus is replenished with money stored in the replenishment container, the management apparatus notifies denominations and the number for each denomination of the surplus money, and that money equivalent to the surplus money needs to be transferred from the money handling apparatus to another money handling apparatus.

8. The money handling system according to claim 1, wherein
in a case where there is surplus money not storable in the storage unit when the money handling apparatus is replenished with money stored in the replenishment container,
the management apparatus
performs determination as to whether there is a unit capable of storing the surplus money other than the storage unit in the money handling apparatus, and determination as to whether there is a money handling apparatus capable of storing the surplus money other than the money handling apparatus, in a predetermined priority order,
determines a method for handling the surplus money, and notifies a result of the determination.

9. The money handling system according to claim 1, wherein the replenishment container is configured not to feed out stored money therefrom.

10. The money handling system according to claim 9, wherein the replenishment container is a bag-type container capable of storing money inside a bag body.

11. The money handling system according to claim 1, wherein the depositing apparatus issues a coupon corresponding to an amount of the deposited money.

12. The money handling system according to claim 1, wherein the money handling apparatus includes a plurality of storage units to store money by denomination.

13. The money handling system according to claim 1, wherein the management apparatus notifies the information on the replenishment work when the money of predetermined denomination for which a quantity of money of each denomination is set in advance is stored in the replenishment container.

14. A money handling method performed by a money handling system, the method comprising:
receiving money deposited in a depositing apparatus including a replenishment container and a normal container, storing money of predetermined denominations for which a quantity of money of each denomination is set in advance for replenishing a money handling apparatus in the replenishment container, and storing money other than the predetermined money for replenishing the money handling apparatus in the normal container; and
notifying information on replenishment work for replenishing the predetermined money handling apparatus with money in the replenishment container.

15. A money depositing apparatus comprising:
a depositing unit configured to receive money;
a transport unit configured to transport the money received in the depositing unit;
a recognition unit configured to recognize the money transported by the transport unit;
a replenishment container and a normal container configured to store the money recognized by the recognition unit; and
a control circuitry configured to store money of predetermined denominations for which a quantity of money of each denomination is set in advance for replenishing a money handling apparatus in the replenishment container, and store money other than the predetermined money for replenishing the money handling apparatus in the normal container.
